(19) United States
(12) Patent Application Publication
(10) Pub. No.: US 2003/0147940 A1
(43) Pub. Date: Aug. 7, 2003

(54) Agent for promoting evacuation of hairballs for animals and animal feed with the agent

(76) Inventor: Nobuyuki Yoshida, Tokyo (JP)

Correspondence Address: MCNEES, WALLACE & NURICK, 100 PINE STREET, P.O. BOX 1166, HARRISBURG, PA, 17108-1166, US

(21) Appl. No.: 10/205,237

(22) Filed: Jul. 25, 2002

(30) Foreign Application Priority Data
Aug. 5, 2001 (JP) 2001-237897

(51) Int. Cl. A23K 1/165

(52) U.S. Cl. 424/442

(57) ABSTRACT

An agent is provided to help animals such as cats, rabbits and ferrets to evacuate the hair taken in at grooming by defecation and thereby avoid a hairball symptom which can cause an alimentary canal fault in the animal. The agent includes more than one of the following materials: kelp, papaya, molokheiya or plantago. In addition, the agent can be incorporated into an animal feed. The agent preferably is only about 1-10% of the content or composition of the animal feed.

### FIELD OF THE INVENTION

The present invention relates generally to an agent for helping animals, such as cats, rabbits and ferrets, to evacuate, by defecation, the hair taken in at grooming.

### BACKGROUND OF THE INVENTION

Healthy animals such as cats, rabbits, ferrets, etc., usually or customarily groom their hair by licking their body. The hair pulled out during the grooming process will be taken into the stomach of the animal and can become a hairball or hairball trichobenzoar in the alimentary canal of the animal. The hairball can take the shape of a ball or discus with the contents of the stomach forming the nuclei of the hairball. The size of hairballs ranges widely. As the hairball cannot be digested by the animal, the hairballs can accumulate in portions of the alimentary canal such as the pylorus, stomach, or the intestines, and directly irritate the membrane of the stomach and bowels. This irritation can result in the animal having an alimentary canal fault such as diarrhea, constipation, gastritis, vomit, decreased appetite, and sometimes even intestinal obstruction, especially for an animal with long hair.

As it is customary for a cat to lick and take in the hair during grooming, it is very common for a cat to have the above-mentioned hairball symptom or problem resulting in an alimentary canal fault. Furthermore, the older the cat, the higher the frequency of the symptom or problem. To avoid the hairball problem, the cat will try to evacuate the hairballs accumulated in the alimentary canal orally or through his or her mouth by periodically vomiting. However, it can be difficult or painful for the cat's owner to see the cat vomiting and the vomit from the cat can be messy and dirty a room forcing the owner to have to clean up the vomit.

When the hair inside the body cannot be evacuated properly through vomiting by the animal, e.g. a cat, or in cases where the animal is unable to vomit, e.g. a rabbit, hairballs can be produced in the alimentary canal. As discussed above, the formation of the hairball can sometimes result in a hairball symptom or problem that causes the alimentary canal fault such as diarrhea, constipation, gastritis, vomit, etc. in the animal. Furthermore, in cases where the animal cannot vomit hair out of the body, e.g. a rabbit, the formation of the hairball and a subsequent alimentary canal fault can cause the death of the animal. One way to avoid the formation of hairballs in animals that cannot properly evacuate the hair by vomiting or that are unable to vomit is to assist the animal in evacuating the hair by defecation.

Other ways to cure or alleviate the hairball symptom or problem include drugs to make the animal vomit, a stomach wash and a lubricating laxative like liquid paraffin, all of which can be used to help evacuate the hairball out of the stomach of the animal. However, daily prevention of hair build-up in the alimentary canal is the best method for preventing the formation of hairballs in the animal.

Therefore, what is needed is an agent that can be regularly provided to an animal to assist the animal in evacuating any ingested hair by defecation. In addition, the agent can be easily incorporated into an animal feed to provide the agent to the animal.

### SUMMARY OF THE INVENTION

One embodiment of the present invention is directed to an agent for promoting the evacuation of hair or hairballs in animals. The agent can help the cat, rabbit or ferret to efficiently evacuate, by defecation, the hair taken in by the animal during grooming or other activities. The agent can include more than one of the following materials: kelp, papaya, molokheiya or plantago, and ingredients having these materials. The materials also include food fiber to absorb moisture in the alimentary canal and promote evacuation of the hairballs by the animal. For the kelp, molokheiya and plantago, a dry powder form is preferred. While for the papaya, a dry powder form and extract form, with the latter being preferred, can be used. The agent can include a liquid form, a powder form, or a gel form. The liquid form of the agent can also be supplied to the animal by being dissolved in water. The powder form or gel form can be supplied to the animal by being mixed with other feed.

Another embodiment of the present invention includes an animal feed having the agent for promoting the evacuation of hairballs from animals. By incorporating the agent into regular meals provided to the animal, the hair taken in by the animals can be efficiently evacuated by the animal and, thus, will not accumulate inside the body of the animal to keep the animal in good health. The animal feed can be dried granular solid body or paste.

Still another embodiment of the present invention is directed to an animal feed that includes 1-10% of the agent for promoting the evacuation of hairballs for animals. The amount of agent used in the feed preferably does not change the taste of the feed and thus, the appetite of the animal will preferably not be reduced or impacted. Therefore, the agent can be applied to the animal during regular meals permitting the hair ingested by the animal to be evacuated more efficiently. Usually for the dry feed with a moisture content below 10%, a content of 1-5% of the agent is desirable, while for canned feed paste with a moisture content of 30-80%, a content of 3-10% of the agent is desirable.

The agent for promoting the evacuation of hair or hairballs of the present invention can be provided to animals such as cats, rabbits, ferrets and chinchillas. The agent can be provided to the animal directly or after being dissolved in water, or by mixing the agent with other feed. Also, the agent can be applied to forefeet or nose of the animal to permit the animal to lick the agent off its body for ingestion into the body.

One advantage of the present invention is that animals such as rabbits, cats and ferrets can more efficiently evacuate by defecation any hair ingested into the body.

Another advantage of the present invention is that vomiting of the animal, especially cats, will be reduced because the hair taken into the body is evacuated by defecation, thereby reducing the need for the animal to vomit in order to evacuate hair.

A further advantage of the present invention is that it can be used to relieve constipation in the animal.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWING

FIG. 1 illustrates the accumulated rates of the hair evacuation of the dry feed containing the agent during the experiment period and of a feed available on the market during the control period.

### DETAILED DESCRIPTION OF THE INVENTION

The agent of the present invention for promoting the evacuation of hair and hairballs by defecation from animals such as a cat, rabbit or ferret, includes more than one of the following ingredients: a cellulose source; a kelp source; and a protease source. In another embodiment of the present invention, the agent can include a vitamin C source for the animal. The protease source and the vitamin C source are preferably in a heat resistant form, but are not required to be in a heat resistant form. The use of the heat resistant form of the protease source and the vitamin C source are preferred when the agent is incorporated into an animal feed in a paste form, which requires higher temperatures during the preparation process. The kelp source preferably includes kelp in a dry powder form. The protease source preferably includes papaya, a papain, in either a dry powder form or extract form, with the extract form being preferred. In another embodiment, the protease source can include pineapple, a bromelain, in either powder form or extract form. The cellulose source provides food fiber to absorb moisture and promote evacuation and preferably includes molokheiya or plantago in a dry powder form. The above examples and forms of the kelp source, protease source and cellulose source are not intended to be limiting and any suitable source and form for the kelp source, protease source and cellulose source can be used in the agent.

The agent can be produced in a liquid form, a gel form and a powder form, all of which can be provided directly to the animal. The liquid form of the agent can also be diluted or dissolved in water and provided to the animal. The powder and gel forms of the agent can be mixed with other ingredients in an animal feed. In one embodiment of the present invention, the agent can be combined with the following ingredients in a dry animal feed: meat meal; corn; wheat; corn gluten meal; beet pulp; animal fat and assorted vitamins and minerals. The formulation of the animal feed in this embodiment can provide: a minimum of 30% protein; a minimum of 10% fat; a maximum of 7% fiber; a maximum of 5% ash; a maximum of 10% moisture; a maximum of 0.085% Mg; a minimum of 0.550% P; and a minimum of 0.700% Ca.

As discussed above, the agent of the present invention can be included in an animal feed for animals. The animal feed can include about 1-15% of the agent and preferably includes about 1-10% of the agent for promoting the evacuation of hair or hairballs from animals and can be a dried granular solid body or a paste. Usually for the dry feed or dried granular solid having a moisture content below 10%, a content of 1-5% of the agent is preferred, while for canned feed paste having a moisture content of 30-80%, a content of 3-10% of the agent is preferred. The use of the agent in the animal feed does not change the taste of the animal feed to the animal and thus generally does not alter the animals appetite for the animal feed. By including the agent in an animal feed, the animal receives the agent on a consistent basis in regular meals and can thereby efficiently evacuate any hair taken into the body to prevent the accumulation of hair inside the body. By preventing the accumulation of hair inside the body, the animal will be kept in a good health.

The following detailed explanation of the invention is based on the following application example and experimental examples. The present invention is not intended to be limited to these application examples and experimental examples.

### APPLICATION EXAMPLE 1

The agent for promoting the evacuation of hair or hairballs in this Application Example 1 was made based on the following formula.

| | |
|---|---|
| Powder of kelp | 6 g |
| Extract of papaya | 1 g |
| Powder of molokheiya | 3 g |

The agent powder for promoting the evacuation of hair or hairballs was made by mixing the materials or ingredients together. The agent powder was then added in a ratio of 1-3% to a cat feed (dry feed) available on the market and subsequently fed to cats.

### EXPERIMENT EXAMPLE 1

A cat having a weight of 3 kg was fed a dry feed having either 0%, 1% and 2% of the agent for promoting the evacuation of hairballs. The agent included in the dry feed was created according to the formula in Application Example 1. A different cat was used for each of the three different dry feed formulations. The cats were provided with two meals per day, with each meal being about 30g. The hair in 20g of defecation from each of the cats was then weighed each day over a four day period. The results are listed in Table 1.

TABLE 1
Hair contained in 20 g of defecation in cats (g, dry weight)

| | Days passed | | | |
|---|---|---|---|---|
| Treatment | 1 | 2 | 3 | 4 |
| Dry feed containing 2% of the agent | 0.05 | 0.25 | 0.31 | 0.29 |
| Dry feed containing 1% of the agent | 0 | 0.10 | 0.19 | 0.17 |
| Control (dry feed without the agent) | 0 | 0 | 0 | 0 |

Compared with the cat fed the control feed, the cats fed the dry feed containing the agent for promoting the evacuation of hairballs had a substantially larger content of hair in their defecation. This confirmed that the agent did have an effect in evacuating the hair and hairballs accumulated inside the body. Furthermore, compared with the cat fed the dry feed containing 1% of the agent, the cat fed the dry feed containing 2% of the agent showed a stronger effect of the agent on the evacuation of the hair and hairball from the body.

### EXPERIMENT EXAMPLE 2

A second experiment on the evacuation of hairballs was carried out by feeding cats a dry feed containing 1% of the agent for promoting the evacuation of hairballs and a dry feed available on the market. The agent included in the dry feed was created according to the formula in Application Example 1. The cats used in this experiment were one Russian Blue female and two Japanese cat females. The cats were judged to be healthy by a regular clinical examination. Additional details on the cats are listed in Table 2.

TABLE 2
Test cats used in Experiment Example 2

| | | | | | Body |
|---|---|---|---|---|---|
| No. | Species | Age | Sex | | weight |
| 1 | Russian Blue | 9 years | female | contraception done | 4.1 kg |
| 2 | Japanese cat | 7 years | female | | 3.8 kg |
| 3 | Japanese cat | 2 years | female | contraception done | 3.2 kg |

The length of the experiment, as shown in Table 3, was for a total of 28 days, including an experiment period of 14 days and an control period of 14 days. The experiment period and the control period each included a preliminary period of 7 days and a watch period of 7 days. During the total length of the experiment, all the test cats were equipped with a big ring about the neck that prevented the cat from licking its body. By preventing the cat from licking its body, no hairs from the cat's body could be ingested by the cat, thereby ensuring that any hair defecated during the experiment would correspond to hair that was forcibly given to the cat for purposes of the experiment.

TABLE 3
|←−−−−−−−−−−−−−−−28 days−−−−−−−−−−−−−−−→|
|←−−−−experimental period−−−−→←−−−−−control period−−−−−→|
| 7 days 7 days 7 days 7 days |
|←−−−−−−−→←−−−−−−−→←−−−−−−−→←−−−−−−−→|
| a b c d |
| perliminary period watch period preliminary period watch period |

| | |
|---|---|
| ↑ | ↑ |
| to give hair forcibly | to give hair forcibly |

The experiment period was as follows. All the test cats were fed with a customary feed during the preliminary period, and then were forcibly given 600 hairs on the evening of the 7^{th} day. The 600 hairs were wrapped or embedded in canned tuna available on the market, similar to a tablet, and were forcibly given to the cat 2-3 hours after the meal in the evening. Feed containing the agent for promoting the evacuation of hairballs was given 2 times (once in the morning and once in the evening) per day during the watch period. The daily amount of the feed given was equal to 3% of the body weight of the test cat, with water being given freely to the cat. Cat litter was prepared for each cat to have the cat evacuate. The defecation from the cats was collected every day during the watch period. The defecation was washed carefully in warm water several times, and was filtered in a sieve of 100 meshes to remove any solid body other than the hair. The hair in the defecation was counted and recorded every day.

The control period was as follows. All the test cats were fed with the customary feed during the preliminary period, and then were forcibly given 600 hairs on the evening of the 7^{th} day. The method for forcibly giving the hairballs to the cats was similar to that described above. A feed available on the market was given 2 times (once in the morning and once in the evening) per day during the watch period. The daily amount of feed given was equal to 3% of the body weight of the test cat, with water being given freely to the cat. Cat litter was prepared for each cat to have the cat evacuate. The defecation from the cats was collected every day during the watch period. The defecation was washed carefully in warm water several times, and was filtered in a sieve of 100 meshes to remove any solid body other than the hair. The hair in the defecation was counted and recorded every day.

The daily amount of hairs evacuated in the experiment period is listed in Table 4. The hair evacuation began after the 1^{st} day and ended after the 6^{th}-7^{th} day, with a peak on the 3^{rd}-4^{th} day after the hair was given to the cat.

TABLE 4
The daily amount of hairs evacuated in the experiment period

| | | | | | | | | | Average daily value |
|---|---|---|---|---|---|---|---|---|---|
| Days passed | 1 | 2 | 3 | 4 | 5 | 6 | 7 | Sum | for the 6 days |
| Test cat | | | | | | | | | |
| No. 1 | 9 | 39 | 151 | 235 | 99 | 45 | 0 | 578 | 96.3 |
| No. 2 | 16 | 133 | 253 | 89 | 103 | 0 | 0 | 594 | 99.0 |
| No. 3 | 6 | 108 | 169 | 195 | 63 | 24 | 0 | 565 | 94.2 |
| Average | 10.3 | 93.3 | 191 | 173 | 88.3 | 23 | 0 | 579 | 96.5 |

The daily hair evacuation rate in the experiment period is listed in Table 5. The average accumulated hair evacuation rate was 96.5%. All the cats had an accumulated hair evacuation rate of more than 90% after the 6^{th} day, showing that the hair was evacuated shortly after being given forcibly.

TABLE 5
The daily hair evacuation rate (%) in the experiment period

| Days passed | 1 | 2 | 3 | 4 | 5 | 6 | 7 | Sum |
|---|---|---|---|---|---|---|---|---|
| Test cat | | | | | | | | |
| No. 1 | 1.5 | 6.5 | 25.2 | 39.2 | 16.5 | 7.5 | 0 | 96.3 |
| No. 2 | 2.7 | 22.2 | 42.2 | 14.6 | 17.2 | 0 | 0 | 98.9 |
| No. 3 | 1.0 | 18.0 | 28.2 | 32.5 | 10.5 | 4.0 | 0 | 94.2 |
| Average | 1.7 | 15.6 | 31.8 | 28.8 | 14.7 | 3.8 | 0 | 96.5 |

The daily amount of hairs evacuated in the control period is listed in Table 6. The hair evacuation began after the 2^{nd} day and lasted even after the 7^{th} day, suggesting that the hair evacuation would last after the 8^{th} day. The peak of the hair evacuation was observed on the 4^{th}-5^{th} day after giving the hair to the cats.

TABLE 6
The daily amount of hairs evacuated in the control period

| Days | | | | | | | | Sum | Sum | A.D.V. | A.D.V. |
|---|---|---|---|---|---|---|---|---|---|---|---|
| passed | 1 | 2 | 3 | 4 | 5 | 6 | 7 | 1-6 | 1-7 | 1-6* | 1-7* |
| Test cat | | | | | | | | | | | |
| No. 1 | 0 | 19 | 53 | 93 | 98 | 61 | 43 | 324 | 367 | 54.0 | 52.4 |
| No. 2 | 0 | 23 | 38 | 77 | 110 | 101 | 74 | 349 | 423 | 58.2 | 60.4 |
| No. 3 | 0 | 22 | 73 | 91 | 71 | 62 | 27 | 319 | 346 | 53.2 | 49.4 |
| Average | 0 | 21.3 | 54.7 | 87 | 93 | 74.7 | 48 | 330.7 | 378.7 | 55.1 | 54.1 |

*A.D.V.-average daily value

The daily hair evacuation rate in the control period is listed in Table 7. The average accumulated hair evacuation rate was 63.0%. The maximum rate accumulated by the 7^{th} day was 70.4%.

TABLE 7
The daily hair evacuation rate (%) in the control period

| Days passed | 1 | 2 | 3 | 4 | 5 | 6 | 7 | Sum |
|---|---|---|---|---|---|---|---|---|
| Test cat | | | | | | | | |
| No. 1 | 0 | 3.2 | 8.9 | 15.1 | 16.5 | 10.2 | 7.2 | 61.1 |
| No. 2 | 0 | 3.8 | 6.4 | 12.9 | 18.3 | 16.9 | 12.1 | 70.4 |
| No. 3 | 0 | 3.6 | 12.1 | 15.2 | 11.8 | 10.4 | 4.5 | 57.6 |
| Average | 0 | 3.6 | 9.1 | 14.4 | 15.6 | 12.4 | 8.0 | 63.0 |

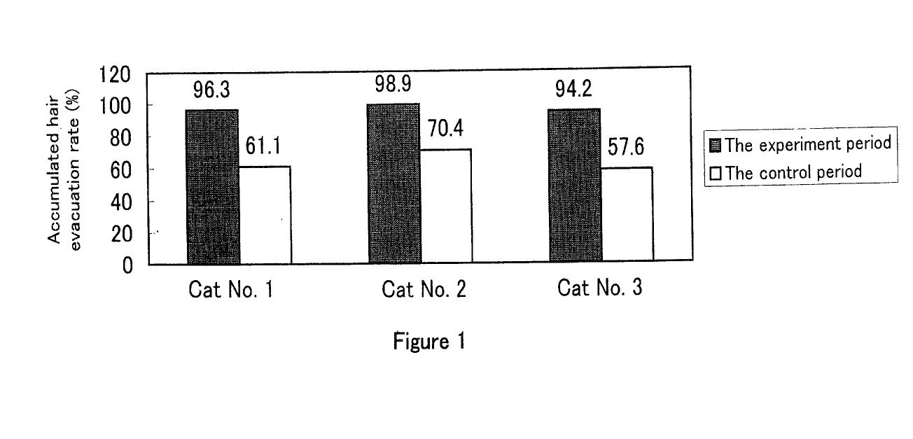

The accumulated rates of the hair evacuation during both the experiment period and the control period for all the three test cats are shown in FIG. 1. For all the test cats the experiment period had a high hair evacuation rate when compared with the control period. As listed in Table 8, a statistical test for comparing the difference in the hair evacuation rate between the experiment period and the control period showed that the feed containing the agent for promoting the evacuation of hairballs did have a significant effect in promoting the evacuation (t-test, P<0.01)

TABLE 8
Average hair evacuation rates (%) of the experiment period
and the control period

| Average hair evacuation rate (%) | | |
|---|---|---|
| The experiment period (n = 3) | The control period (n = 3) | |
| 96.5 | 63.0 | P < 0.01* |

*based on t-test

The daily hair evacuation rates of the experiment period and the control period and the ratio of the hair evacuation rate of the experiment period to that of the control period (the experiment period/the control period) are shown in Table 9. The hair evacuation rate accumulated by the 7^{th} day was 96.5% for the experiment period and 63.0% for the control period, and the ratio of the experiment period to the control period was 1.5, showing that the evacuation rate of the experiment period was higher than that of the control period. Also, during the experiment period, the hair evacuation was observed on the 1^{st} day after the hair giving, while during the control period, it was observed on the 2^{nd} day, or a day later. Thus, the experiment period showed an earlier start, earlier peak and earlier finish of the hair evacuation than the control period.

TABLE 9
The daily hair evacuation rates (%) of the experiment period
and the control period

| Days passed | 1 | 2 | 3 | 4 | 5 | 6 | 7 | Sum |
|---|---|---|---|---|---|---|---|---|
| The experiment | 1.7 | 15.6 | 31.8 | 28.8 | 14.7 | 3.8 | 0 | 96.5 |
| period (%) | | | | | | | | |
| The control | 0 | 3.6 | 9.1 | 14.4 | 15.6 | 12.4 | 8.0 | 63.0 |
| period (%) | | | | | | | | |
| The ratio* | — | 4.3 | 3.5 | 2.0 | 0.9 | 0.3 | — | 1.5 |

*The ratio = the experiment period/the control period

Thus, according to the above results, the dry feed containing the agent for promoting the evacuation of hairballs made animals such as cats, rabbits, ferrets and chinchillas evacuate the hair taken in early and efficiently. It was suggested that this feed would make the hair separated with each other and with the wall of the alimentary canal, which resulted in a smooth pass of the hair through the alimentary canal.

### EXPERIMENT EXAMPLE 3

A third experiment on the evacuation of hairballs was carried out identical to that in Experiment Example 2, except that for the watch portion of the experiment period lasted for only six days and a hairball control adult cat feed produced by Company A was used instead of the dry cat food with the agent.

The daily amount of hairs evacuated in the experiment period is listed in Table 10. The hair evacuation began after the 1^{st} day with a peak on the 5^{th}-6^{th} day after the hair was given to the cat.

TABLE 10
The daily amount of hairs evacuated in the experiment period

| | | | | | | | | | Average daily value |
|---|---|---|---|---|---|---|---|---|---|
| Days passed | 1 | 2 | 3 | 4 | 5 | 6 | 7 | Sum | for the 6 days |
| Test cat | | | | | | | | | |
| No. 1 | 8 | 46 | 51 | 93 | 124 | 125 | — | 447 | 74.5 |
| No. 2 | 14 | 71 | 92 | 82 | 113 | 110 | — | 482 | 80.3 |
| No. 3 | 11 | 78 | 104 | 74 | 111 | 94 | — | 472 | 78.7 |
| Average | 11 | 65 | 82.3 | 83 | 116 | 109.7 | — | 467 | 77.8 |

The daily hair evacuation rate in the experiment period was listed in Table 11. The average accumulated hair evacuation rate was 77.8%. The maximum rate accumulated by the 6^{th} day was 80.3%.

TABLE 11
The daily hair evacuation rate (%) in the experiment period

| Days passed | 1 | 2 | 3 | 4 | 5 | 6 | 7 | Sum |
|---|---|---|---|---|---|---|---|---|
| Test cat | | | | | | | | |
| No. 1 | 1.3 | 7.7 | 8.5 | 15.5 | 20.7 | 20.8 | — | 74.5 |
| No. 2 | 2.3 | 11.8 | 15.3 | 13.7 | 18.8 | 18.3 | — | 80.3 |
| No. 3 | 1.8 | 15.0 | 17.3 | 12.3 | 18.5 | 15.7 | — | 78.6 |
| Average | 1.8 | 10.8 | 13.7 | 13.8 | 19.3 | 18.3 | — | 77.8 |

### EXPERIMENT EXAMPLE 4

A fourth experiment on the evacuation of hairballs was carried out identical to that in Experiment Example 2, except that for the watch portion of the experiment period lasted for only six days and a hairball control adult cat feed produced by Company B was used instead of the dry cat food with the agent.

The daily amount of hairs evacuated in the experiment period is listed in Table 12. The hair evacuation began after the 1st day with a peak on the 5^{th}-6^{th} day after the hair was given to the cat.

TABLE 12
The daily amount of hairs evacuated in the experiment period

| | | | | | | | | | Average daily value |
|---|---|---|---|---|---|---|---|---|---|
| Days passed | 1 | 2 | 3 | 4 | 5 | 6 | 7 | Sum | for the 6 days |
| Test cat | | | | | | | | | |
| No.1 | 10 | 51 | 58 | 103 | 131 | 102 | — | 455 | 75.8 |
| No.2 | 11 | 53 | 112 | 79 | 101 | 85 | — | 441 | 73.5 |
| No.3 | 7 | 95 | 98 | 82 | 134 | 71 | — | 487 | 81.1 |
| Average | 9.3 | 66.3 | 89.3 | 88 | 122 | 86 | — | 461 | 76.8 |

The daily hair evacuation rate in the experiment period was listed in Table 13. The average accumulated hair evacuation rate was 76.8%. The maximum rate accumulated by the 6^{th} day was 81.1%.

TABLE 13
The daily hair evacuation rate (%) in the experiment period

| Days passed | 1 | 2 | 3 | 4 | 5 | 6 | 7 | Sum |
|---|---|---|---|---|---|---|---|---|
| Test cat | | | | | | | | |
| No. 1 | 1.6 | 8.4 | 9.7 | 17.1 | 21.8 | 17.2 | — | 75.8 |
| No. 2 | 1.9 | 8.8 | 18.6 | 13.2 | 16.7 | 14.1 | — | 73.5 |
| No. 3 | 1.1 | 15.9 | 16.4 | 13.6 | 22.3 | 11.9 | — | 81.1 |
| Average | 1.5 | 11.0 | 14.9 | 14.6 | 20.3 | 14.4 | — | 76.8 |

### SUMMARY FOR EXPERIMENTAL EXAMPLES 2-4

The average daily hair evacuation rates of the experiment period for each of the cat foods, e.g. the dry cat food with the agent, the cat food from Company A and the cat food from Company B, and the control period are shown in Table 14. The hair evacuation rate accumulated by the 6^{th} day was 96.5% for the dry cat food with the agent, 77.8% for the cat food from Company A, 76.8% for the cat food from Company B and 55.1% for the control period. These results show that the evacuation rate of the dry cat food with the agent of the present invention was higher than that of the control period and the other cat foods. The experiment also shows that the dry cat food of the present invention had an earlier peak and an earlier finish of the hair evacuation than the control period and the other cat foods.

TABLE 14
The daily hair evacuation rates (%) of the experiment
periods and the control period

| Days passed | 1 | 2 | 3 | 4 | 5 | 6 | Sum |
|---|---|---|---|---|---|---|---|
| Dry cat food with Agent | 1.7 | 15.6 | 31.8 | 28.8 | 14.7 | 3.8 | 96.5 |
| Cat food from Company | 1.8 | 10.8 | 13.7 | 13.8 | 19.3 | 18.3 | 77.8 |
| A | | | | | | | |
| Cat food from Company | 1.5 | 11.0 | 14.9 | 14.6 | 20.3 | 14.4 | 76.8 |
| B | | | | | | | |
| The control period (%) | 0 | 3.6 | 9.1 | 14.4 | 15.6 | 12.4 | 55.1 |

TABLE 15
Table 15 provides a comparison of the average daily hair evacuation
rates for each of the cats of Experiment Examples 2-4.

| Test cat | No. 1 | No. 2 | No. 3 | Average |
|---|---|---|---|---|
| Dry cat food with Agent | 96.3 | 98.9 | 94.2 | 96.5 |
| Cat food from Company A | 74.5 | 80.3 | 78.6 | 77.8 |
| Cat food from Company B | 75.8 | 73.5 | 81.1 | 76.8 |
| Control | 54.0 | 58.2 | 53.2 | 55.1 |

In the Experimental Examples 2-4 summarized above, it is shown that the dry cat food with the agent of the present invention, when compared with an adult cat feed having no hairball control ingredient and the hairball control adult cat feeds from Company A and Company B, had a stronger effect on the evacuation of hairballs accumulated inside the body of the cat.

Also, the hairball control adult cat feeds from Company A and by Company B had a peak of hair evacuation by the cat on the 4^{th} or 5^{th} day after the hair was given to the cat, while the cat food with the present invention had its peak on the 3^{rd} day, or one or more days earlier. This suggests that the hair would be more likely evacuated before forming hairballs, proving that the dry cat food with the agent for promoting the evacuation of hairballs evacuates the hair more effectively than those cat foods of Company A and Company B.

Regarding the mechanism of promoting the evacuation of hair by the agent of the present invention, the following was observed. When fed with a dry cat food with the agent of the present invention, the cats evacuated the hairs without the hairs adhering to each other. This suggests that the protease included in the agent of the present invention operates to break apart the protein adhering the hairball to the inner wall of the intestine, which makes the hairball inside the intestine easily separated from the inner wall and evacuated with the defecation. In addition, when the cats were fed the dry cat food with the agent of the present invention, the hairs evacuated by the cats had a thin jellylike material on its surface. This suggests that this jellylike material is water-soluble food fiber, which makes the hair pass through the alimentary canal smoothly.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

What is claimed is:

1. An agent for promoting the evacuation of hair from animals, the agent comprising at least two sources selected from the group consisting of a kelp source, a protease source and a cellulose source.

2. The agent of claim 1 wherein the protease source is papaya.

3. The agent of claim 2 wherein the papaya has a dry powder form

4. The agent of claim 2 wherein the papaya has an extract form.

5. The agent of claim 1 wherein the cellulose source comprises molokheiya having a dry powder form.

6. The agent of claim 1 wherein the cellulose source comprises plantago having a dry powder form.

7. The agent of claim 1 wherein the protease source is heat resistant.

8. The agent of claim 1 further comprises a vitamin C source.

9. The agent of claim 8 wherein the vitamin C source is heat resistant.

10. The agent of claim 1 wherein the kelp source has a dry powder form.

11. The agent of claim 1 having a form selected from the group consisting of a liquid form, a gel form and a powder form.

12. An agent for promoting the evacuation of hair from animals comprising at least two members of the group consisting of kelp, papaya, molokheiya and plantago.

13. The agent of claim 12 comprising kelp, papaya and molokheiya.

14. The agent of claim 12 comprising kelp, papaya and plantago.

15. An animal feed for promoting the evacuation of hair from animals, the animal feed comprising an agent having at least two sources selected from the group consisting of a kelp source, a protease source and a cellulose source.

16. The animal feed of claim 15 wherein the agent comprises about 1-10% of the content of the animal feed.

17. The animal feed of claim 15 wherein the animal feed has a dried granular solid body form.

18. The animal feed of claim 17 wherein the agent comprises about 1-5% of the content of the animal feed.

19. The animal feed of claim 15 wherein the animal feed has a paste form.

20. The animal feed of claim 19 wherein the agent comprises about 3-10% of the content of the animal feed.
